(19) United States
(12) Patent Application Publication
(10) Pub. No.: US 2025/0261678 A1
(43) Pub. Date: Aug. 21, 2025

(54) Method and apparatus for coating a foodstuff product with flowable material

(71) Applicant: SOREMARTEC S.A., Senningerberg (LU)

(72) Inventors: Patrick DE FELICE, Senningerberg (LU); Andre JUSTUS, Senningerberg (LU)

(73) Assignee: SOREMARTEC S.A., Senningerberg (LU)

(21) Appl. No.: 19/045,188

(22) Filed: Feb. 4, 2025

(30) Foreign Application Priority Data
Feb. 15, 2024 (IT) 102024000003268

(51) Int. Cl. A23P 20/18; A23P 20/12; B05C 13/02

(52) U.S. Cl. CPC A23P 20/18; A23P 20/12; B05C 13/02

(57) ABSTRACT

A foodstuff product is coated with flowable material. In a direction of advance (K) is fed a succession of rows of products (Q) oriented in a direction transverse to the direction of advance (K). The products of the succession of rows are arranged along a plurality of reference axes (Yi) parallel to the direction of advance. To coat the undersides of products in the rows with flowable material, main steps may include: supplying a group of flows of flowable material (F1) that follow paths of supply in a direction of supply (K′) opposite to direction of advance (K}. Supply paths are parallel to one another in staggered positions, transverse to direction of advance, with respect to reference axes (Yi); and gathering material of the group of flows in the first position (P1) on second conveying surface (II), forming thereon substrates of material (M) in positions aligned with reference axes (Yi).

### CROSS REFERENCE TO RELATED APPLICATION(S)

This claims the benefit of Italian Patent Application No. 102024000003268, filed on Feb. 15, 2024, the disclosures of which are herein incorporated by reference in their entirety.

### FIELD OF THE INVENTION

The present invention relates to a method and an apparatus for coating a foodstuff product with flowable material, in particular a confectionery product.

For coating foodstuff products completely with a flowable material, for example confectionery products such as biscuits, pralines, wafers, etc., in the context of industrial production, it is known to:
provide a first conveyor for feeding a succession of rows of products in a direction of advance;
generate a layer of flowable material on the conveying surface of a second conveyor and receive the products on the layer of flowable material generated on the conveying surface of the second conveyor so as to coat the undersides of the products with flowable material;
feed the products received on the second conveyor in a direction of advance; and
supply from above a flow of flowable material onto the conveying surface of the second conveyor so as to coat the upper sides of the products that are fed in the direction of advance.

For implementation of such a process, the solutions of the prior art normally comprise first means for supplying the flowable material to form the aforesaid layer of material on the conveying surface of the conveyor that are normally arranged in a region upstream of the position in which the products are received on the conveyor, and second means for supplying the flowable material to coat the upper sides of the products that are, instead, arranged downstream of the aforesaid position.

In this context, the object of the present invention is to provide a solution that is improved as compared to known solutions. In particular, the object of the present invention is to achieve one or more of the following purposes:
coating the products with the flowable material in an effective and complete way;
maintaining a proper alignment of the products before and after the process of coating of the products;
providing a solution that will enable reduction of the length of the production line; and providing a solution that is simple both from the constructional standpoint and from the standpoint of its operation.

In general, the present invention regards a method according to claim 1 and an apparatus according to claim 7.

The claims form an integral part of the teachings provided herein.

Further characteristics and advantages of the present invention will emerge clearly from the ensuing description with reference to the annexed drawings, which are provided purely by way of non-limiting example and in which:

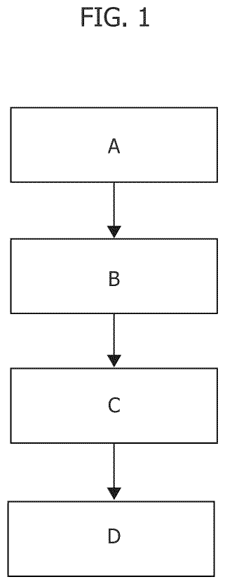

FIG. 1 is a schematic illustration of an example of the method described herein;

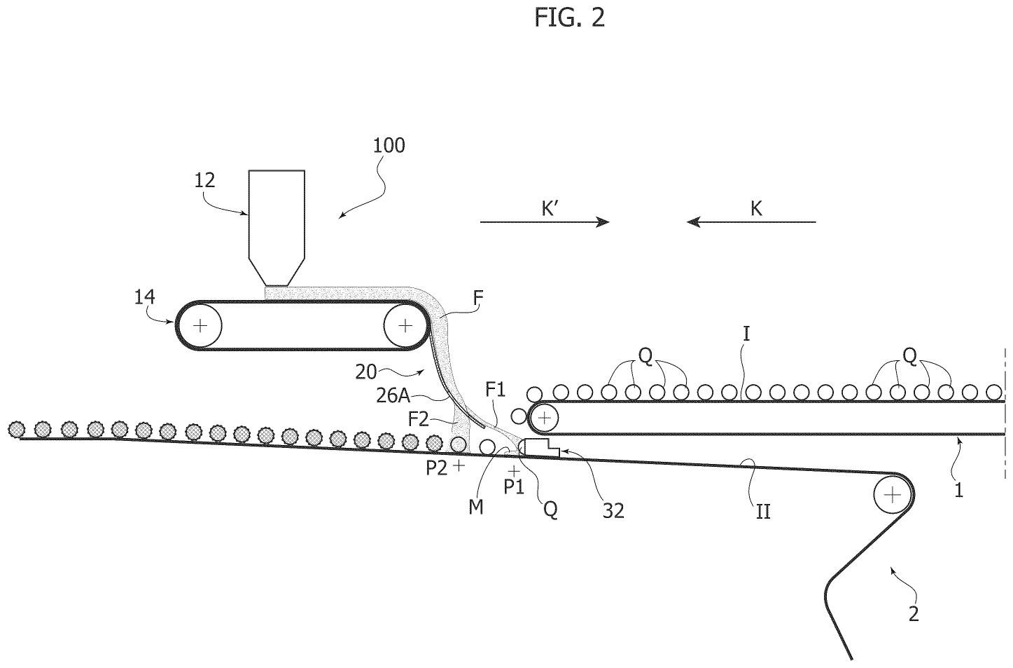

FIG. 2 is a schematic illustration of an example of the apparatus described herein, according to a side view;

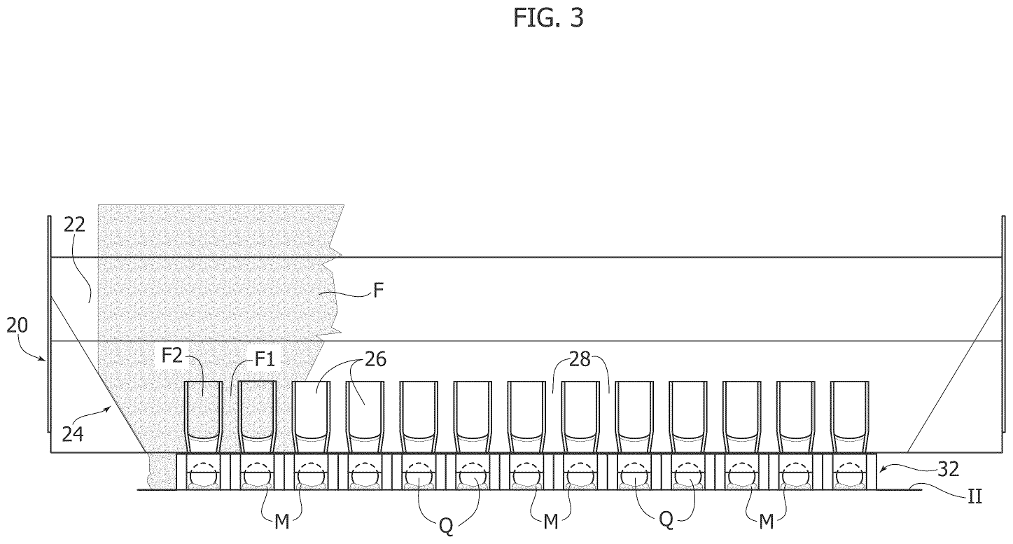

FIG. 3 illustrates the apparatus of FIG. 2 according to a front view;

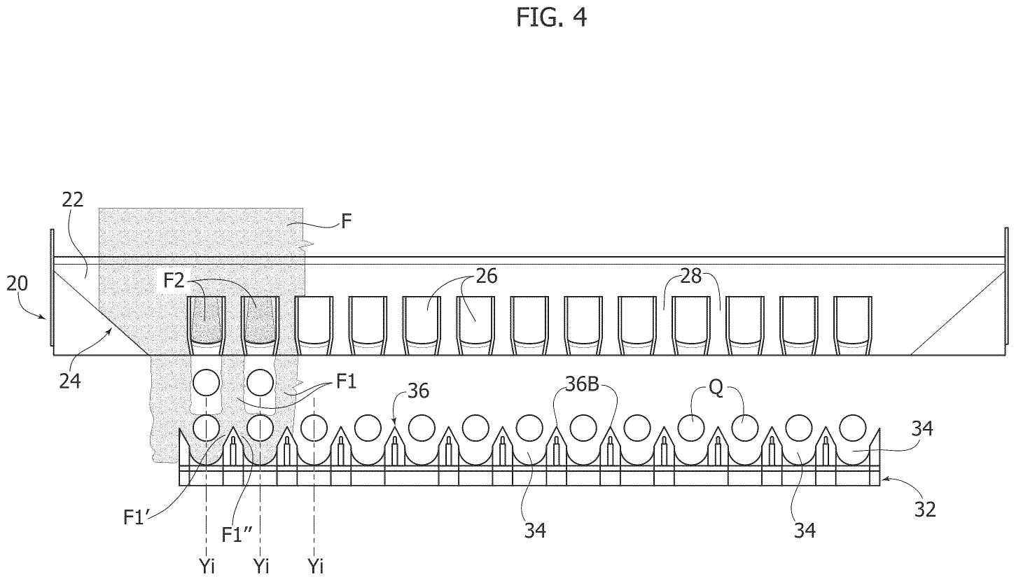

FIG. 4 illustrates the apparatus of FIG. 2 in plan view; and

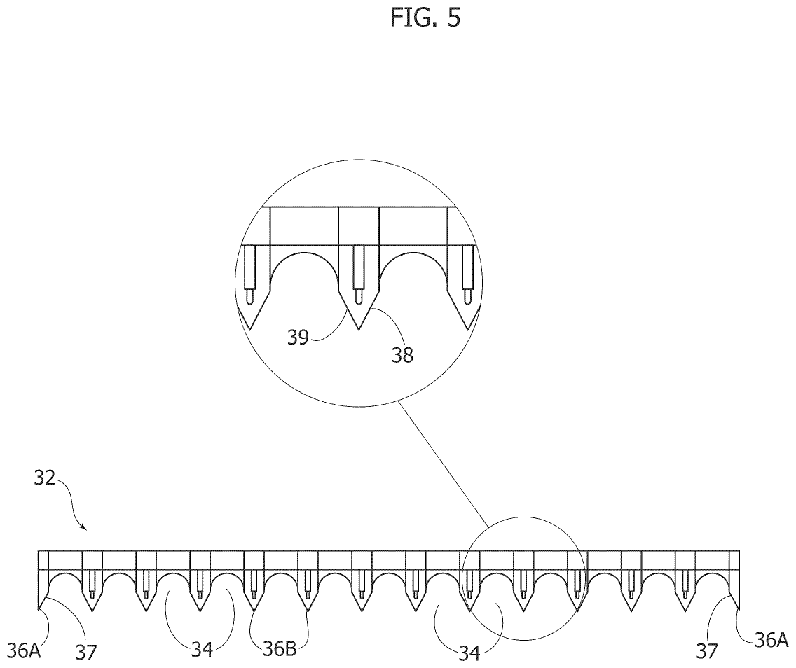

FIG. 5 illustrates a component of the apparatus of FIGS. 2-4 in plan view.

In the ensuing description various specific details are illustrated aimed at enabling an in-depth understanding of the embodiments. The embodiments may be obtained without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

As anticipated above, the solution described herein regards a method and an apparatus for coating a foodstuff product with flowable material.

The foodstuff product may, for example, be a confectionery product, such as a biscuit, a praline, a wafer, etc.

In general, it should be noted that the teachings provided herein can be used for applications on foodstuff products of any kind.

The flowable material may be a granular material, a liquid, a creamy or pasty material, etc.

In general, the method described herein comprises the following steps (see FIG. 1):
feeding in a direction of advance a succession of rows of products oriented in a direction transverse to the direction of advance, where the products of said succession of rows are moreover arranged along a plurality of reference axes parallel to the direction of advance (step A),
wherein said step of feed includes transferring each row of products from a first conveying surface of a first conveyor to a second conveying surface of a second conveyor, set underneath said first conveying surface and set downstream of said first conveying surface with reference to said direction of advance, said row of products being received on said second conveying surface in a first position in said direction of advance;
supplying a group of flows of material that follow paths of supply in a direction of supply of the material opposite to the direction of advance of said succession of rows of products, said paths of supply being substantially parallel to one another and being in positions staggered, in a direction transverse to the direction of advance, with respect to the plurality of reference axes (step B),
wherein during advance along said paths of supply said flows of said group pass through said rows of products along either side of each product of the rows themselves;
gathering the material of said group of flows of material in said first position on said second conveying surface, forming thereon substrates of said material in positions aligned with said plurality of reference axes (step C),
wherein said step of transferring each row of products from said first conveying surface to said second conveying surface includes arranging the products of each row on said substrates of material in said first position so that the undersides of said products will be coated with said material; and
   supplying a further flow of material or a further group of flows of material to a second position on said second conveying surface, which is located downstream of said first position in said direction of advance, wherein said further flow of material or said further group of flows of material is laid on said second conveying surface, coating the upper sides of the products of said rows that advance in the direction of advance (step D).

In one or more preferred embodiments, the aforesaid substrates are in the form of accumulations of said material.

In one or more preferred embodiments, the method comprises supplying a main flow of material in the direction of supply of the material and dividing the main flow into the aforesaid group of flows of material and into the aforesaid further group of flows of material, wherein the flows of the aforesaid group of flows of material set themselves, two by two, on either side of each flow of material of said further group of flows of material.

In view of the foregoing, the method described herein is configured for supplying the flowable material to coat the undersides of the products starting from a region above the second conveyor and shifted in the direction of advance with respect to the aforesaid first position.

The aforesaid material is supplied in the form of a plurality of separate and distinct flows of material, which flow in a direction opposite to the direction of advance of the products and are able to pass through the rows of products along either side of each product of the rows themselves so as to reach the first position without interfering with advance of the products.

The material brought into this position is then gathered to form a plurality of substrates in positions aligned with the aforesaid reference axes so that the products of the individual rows will rest on the aforesaid substrates when they are received, in the same position, on the conveying surface of the second conveyor.

In view of the foregoing, it will be understood that, according to the method described herein, it is hence no longer necessary, as instead occurs in the solutions according to the prior art, to provide the means of supply of the flowable material, for example hoppers and chutes, in a position upstream of the aforesaid first position. Incidentally, it will be noted in this connection that normally present upstream of the first position is also the first conveyor so that the space available is limited. In the solutions of the prior art, to overcome this problem, the path of the second conveyor is lengthened so that this will reach regions of the production line where it is possible to obtain greater space for installation of the means of supply of the flowable material.

The method described herein hence makes it possible to provide a production line that is less cumbersome as compared to known solutions.

The method described herein moreover makes it possible to supply the material from a single hopper, thus simplifying considerably the structure and operation of the apparatus that implements the method itself.

According to the preferred embodiment mentioned previously, the main flow of material referred to above and the two groups of flows of material into which it is then divided can be supplied via a single chute, this leading to a further simplification of the apparatus as well as to a further reduction of the corresponding encumbrance.

Finally, the method described herein enables coating of the products in a complete and effective way and at the same time maintains proper alignment of the products, which is advantageous for the subsequent stations of the production line.

With reference now to FIGS. 2 to 4, these illustrate an example of the apparatus described herein for implementation of the method illustrated above.

In one or more preferred embodiments like the one illustrated, the apparatus described herein-designated as a whole by the reference number 10 in the figures-comprises:
a first conveyor 1, defining a first conveying surface I for feeding products Q in a direction of advance K; and
a second conveyor 2, defining a conveying surface II for feeding the products Q in the direction of advance K and comprising a part set underneath the conveyor 1 and a further part extending beyond the conveyor 1 in the direction of advance K.

The conveying surface II is located in a position lower than the conveying surface I, at least for a part of its extension.

During operation of the apparatus, the products Q are arranged on the conveying surface I according to a succession of rows oriented in a direction transverse to the direction of advance K.

Moreover, the products Q of the aforesaid rows are arranged along a plurality of reference axes Yi parallel to the direction of advance K.

When the rows of products Q reach, in succession, the downstream end of the conveyor 1, they are transferred onto the conveyor 2 as a result of a small jump from the conveying surface I of the conveyor 1 to the conveying surface II, set at a lower level, of the conveyor 2. On the conveying surface II of the conveyor 2 each row of products is received in a position P1.

The rows of products maintain, on this surface, the same alignment as that referred to above.

In one or more preferred embodiments like the one illustrated, the apparatus 10 comprises a supply system 100 for supplying the flowable material to the conveying surface II of the conveyor 2.

In one or more preferred embodiments like the one illustrated, in the area where the supply system 100 is provided, the conveying surface II presents a stretch slightly uphill in the direction of advance K in order to favour stay, in the same area, of the material deposited thereon by the supply system 100.

In one or more preferred embodiments like the one illustrated, the supply system 100 comprises a hopper 12 configured for containing the flowable material to be supplied, and a belt conveyor 14 set underneath the hopper 12 for receiving the material delivered therefrom.

In one or more preferred embodiments like the one illustrated, the supply system further comprises a chute 20 that is configured for receiving the material supplied by the conveyor 14 and for supplying the material itself in a direction of supply K′ opposite to the direction of advance K of the products.

Incidentally, it should be noted that by direction of advance K and direction of supply K′ are here meant generically the directions of displacement according to a plan view of the products or of the flowable material (with reference to the example illustrated, to the left for the direction of advance K, and to the right for the direction of supply K′) irrespective of whether the displacement of the products or of the material occurs in horizontal or else inclined planes.

In one or more preferred embodiments like the one illustrated, the chute 20 is set facing the first conveyor 1.

In one or more preferred embodiments like the one illustrated, the chute 20 comprises a first section 22 that receives the material from the belt conveyor 14 and supplies it by gravity according to a main flow F.

In one or more preferred embodiments like the one illustrated, the flow F has a width, in a direction transverse to the direction of supply K′, that is greater than the length of the rows of products Q.

In one or more preferred embodiments like the one illustrated, the chute 20 further comprises a second section 24, which follows the section 22 in the direction of supply K′ and performs the function of dividing the flow of material F into two distinct groups of flows of material F1, F2.

In particular, in one or more preferred embodiments like the one illustrated, the section 24 comprises a series of outlets 26, which are arranged in a second position P2 in the direction of advance K and are aligned with the plurality of reference axes Yi.

In one or more preferred embodiments like the one illustrated, the outlets 26 are provided with bottom openings 26A facing the conveying surface II of the conveyor 2.

The outlets 26 are configured for defining paths of supply of the material in vertical planes aligned with the plurality of reference axes Yi.

In operation, the outlets 26 generate the flows of material F2, which are deposited, from above, on the conveying surface II of the conveyor 2 to coat the upper sides of the products Q of the various rows of products while these are fed in the direction of advance K.

In one or more preferred embodiments like the one illustrated, the section 24 further comprises a series of passages 28 that extend in the direction of supply K′ and are arranged, two by two, on either side of each outlet 26.

The passages 28 extend in the direction of supply K′, beyond the series of outlets 26, to carry the material to the position P1 on the conveying surface II of the conveyor 2. They identify paths of supply of the material in the direction of supply K′ that are located in positions staggered, in a direction transverse to the direction of advance K, with respect to the reference axes Yi.

During operation, the series of passages 28 determines the flows of material F1, which, as they reach the conveying surface II of the conveyor 2, come to pass through the rows of products Q that advance in the direction K along either side of each product Q of the rows themselves.

In one or more preferred embodiments like the one illustrated, the supply system 100 further comprises a barrier member 32, which is provided on the conveying surface II of the conveyor 2, for blocking the flows of material F1 coming from the chute 20 and gathering the corresponding material in the position P1.

In one or more preferred embodiments like the one illustrated, the barrier member 32 is configured for defining, on the conveying surface II, a series of housings 34 into which the material of the flows F1 is gathered in the form of substrates M, in particular accumulations M.

The housings 34 may be arranged in the position P1 or slightly upstream thereof; the person skilled in the sector will understand in fact that the movement of the conveying surface II acts so as to distribute the material gathered in the direction of advance K so that the accumulations M in any case tend to project from the housings 34 and hence move into the position P1 even in the case where the housings 34 are arranged slightly upstream of said position.

In one or more preferred embodiments like the one illustrated, the housings 34 are aligned with the reference axes Yi.

Consequently, the rows of products Q that are received in succession on the conveying surface II of the conveyor 2, in the position P1, come to rest directly on the accumulations of material M formed within the housings 34.

In order to direct the material that is supplied by the flows F1 into the housings 34, with respect to which, as emerges from the foregoing, the flows F1 follow paths of supply that are staggered in a transverse direction, the barrier member 32 comprises a series of deviator elements 36.

The deviator elements 36 are provided for delimiting inlets 38 to the housings 34 and directing the material towards the inside of these housings.

In one or more preferred embodiments like the one illustrated, the series of deviator elements 36 comprises two outer deviator elements 36A and two intermediate deviator elements 36B.

One deviator element 36A and the deviator element 36B adjacent thereto define the inlet 38 to the first housing 34 of the series of housings, and, likewise, the other deviator element 36A and the deviator element 36B adjacent thereto define the inlet 38 to the last housing 34 of the series of housings.

On the other hand, each deviator element 36B co-operates with the two deviator elements 36A and/or 36B adjacent thereto for delimiting, instead, the inlets 38 of two consecutive housings 34 of the series of housings.

In one or more preferred embodiments like the one illustrated, the deviator elements 36A have respective inclined surfaces 37 configured for intercepting the two outermost flows of material F1 and directing them into the two housings 34 respectively associated to the two deviator elements 36A.

In one or more preferred embodiments like the one illustrated, the deviator elements 36B each have, instead, two inclined surfaces 38, 39 that form a wedge-shaped profile in plan view, to divide a respective intermediate flow of material F1 into two partial flows F1^{I}, F1^{II}.

The two partial flows F1^{I}, F1^{II} are directed by the surfaces 38, 39 themselves into the two housings 34 associated to the individual deviator element 36B.

Preferably, the two inclined surfaces 38, 39 intersect in a vertical plane aligned with a respective passage 28 of the chute 20 in the direction of advance K.

Operation of the apparatus described above first of all envisages loading the flowable material into the hopper 12.

This material is delivered by the hopper 12 onto the conveyor belt 14, which then feeds it to the chute 20.

The material fed to the chute 20 forms by gravity the main flow of material F directed in the direction of supply K′.

At the section 24 of the chute 20, the flow F is divided into the two groups of flows F1, F2.

The flows F2 drop from above, through the outlets 26, onto the rows of products Q that move into the position P2 as they are fed in the direction of advance K. In this way, the material of the flows F2 comes to coat the upper sides of the products Q.

The flows F1 flow, instead, along the passages 28 and reach the position P1 and the barrier member 32 on the conveying surface II. During transfer from the passages 28 to the position P1, the flows F1 come to pass through the rows of the products Q along either side of each product Q of the rows themselves.

In one or more preferred embodiments like the one illustrated, the passages 28 terminate at a certain distance from the position P1, in which case the flows F1 reach this position as a result of the momentum gathered by the flows F1 during their descent down the chute 20.

At the position P1, the material of the flows F1 gathers within the housings 34 to form respective accumulations of material M.

The rows of products Q that are transferred from the conveying surface I of the conveyor 1 to the conveying surface II of the conveyor 2 deposit directly on the accumulations of material M. In this way, the material of these accumulations comes to coat the undersides of the products Q.

In view of the foregoing, the supply system 100 is able to supply the material for coating the products Q in order to coat both the undersides and the upper sides thereof, even though it is set with its own means of supply (specifically, the hopper 12, the conveyor 14, and the chute 20) downstream of the conveyor 1 and above the conveyor 2. The aforesaid system advantageously occupies a space limited in the direction of advance K of the products Q and envisages an operation that enables an optimal production quality to be obtained and at the same time makes it possible to preserve proper alignment of the products Q to the advantage of the subsequent stations of the production line.

It should now be noted that in an alternative embodiment, the method and apparatus described herein can be configured for coating the upper sides of the products Q not through the flows of material F2 referred to above, supplied in the direction of supply K′ alongside the flows of material F1, but, instead, via a single flow of material or else a group of flows of material supplied in the opposite direction, i.e., in the direction of advance K.

According to the above alternative embodiment (not illustrated), the supply system may for example envisage, underneath the hopper 12, a further belt conveyor configured for supplying a part of the material delivered by the hopper in the direction of advance K, and a second chute configured for receiving the material from the aforesaid belt conveyor and supplying a flow of material or else a plurality of flows of material to the conveying surface II of the conveyor 2 in the direction of advance K.

In a way similar to what has been illustrated above with reference to the flows F2, the aforesaid flow of material or plurality of flows of material drops from above onto the rows of products Q, in this way coming to coat the upper sides of the products Q.

Of course, without prejudice to the principle of the invention, the details of construction and the embodiments may vary, even significantly, with respect to what has been illustrated herein purely by way of non-limiting example, without thereby departing from the scope of the invention, as defined by the annexed claims.

1. A method for coating a foodstuff product with flowable material, the method comprising:
feeding in a direction of advance (K) a succession of rows of products (Q) oriented in a direction transverse to the direction of advance (K), wherein the products of said succession of rows are moreover arranged along a plurality of reference axes (Yi) parallel to the direction of advance,
wherein said step of feed includes transferring each row of products from a first conveying surface (I) of a first conveyor (1) to a second conveying surface (II) of a second conveyor (2), set underneath said first conveying surface (I) and set downstream of said first conveying surface with reference to said direction of advance (K), said row of products being received on said second conveying surface (II) in a first position (P1) in said direction of advance,
supplying a group of flows of flowable material (F1) that follow paths of supply in a direction of supply (K′) opposite to the direction of advance (K) of said succession of rows of products, said paths of supply being parallel to one another and being in positions staggered, in a direction transverse to the direction of advance, with respect to the plurality of reference axes (Yi),
wherein, during advance along said paths of supply, said flows of said group (F1) pass through said rows of products (Q) along either side of each product of the rows themselves;
gathering the material of said group of flows of material in said first position (P1) on said second conveying surface (II), forming thereon substrates of said material (M) in positions aligned with said plurality of reference axes (Yi),
wherein said step of transferring each row of products from said first conveying surface (I) to said second conveying surface (II) includes arranging the products of each row on said substrate of material (M) in said first position (P1) so that the undersides of said products will be coated with said material; and
supplying a further flow of material or a further group of flows of material (F2) to a second position (P2) on said second conveying surface (II) that is located downstream of said first position (P1) in said direction of advance (K), wherein said further flow of material or said further group of flows of material (F2) deposits on said second conveying surface (II) to coat the upper sides of the products of said rows that are fed in the direction of advance (K).

2. The method according to claim 1, comprising supplying a main flow of material (F) in the direction of supply (K′) of the material and dividing the main flow into said group of flows of material (F1) and into said further group of flows of material (F2), wherein the flows of said group of flows of material (F1) set themselves, two by two, on either side of each flow of material of said further group of flows of material (F2).

3. The method according to claim 1, wherein said step of gathering the material of said group of flows of material (F1) in said first position (P1) on said second conveying surface (II) includes gathering said material by way of a barrier member (32) provided on said second conveying surface (II) of said second conveyor (2) to block said group of flows of material (F1) in said first position (P1).

4. The method according to claim 3, wherein said material is gathered in the form of substrates within housings (34) that are defined on said second conveying surface (II) by said barrier member (32) and are aligned with said plurality of reference axes (Yi).

5. The method according to claim 4, wherein said group of flows of material (F1) are deviated into said housings (34) by way of deviator elements (36) provided on said barrier member (32).

6. The method according to claim 2, wherein supplying a main flow of material (F) in the direction of supply (K′) of the material includes supplying said material to a chute (20) positioned above said second conveying surface (II) of said second conveyor (2) and configured for supplying by gravity said material in said direction of supply (K′), and wherein dividing the main flow (F) into said group of flows of material (F1) and into said further group of flows of material (F2) includes:
supplying a part of the material of said main flow (F) to a series of outlets (26) of said chute (20) that are arranged in said second position (P2) and are aligned with said plurality of reference axes (Yi), the material supplied through said outlets (26) constituting said further group of flows of material (F2); and
supplying the other part of the material of said main flow (F) to a series of passages (28) that are arranged, two by two, at the opposite ends of said series of outlets (26), the material supplied through said passages (28) constituting said group of flows of material (F1).

7. An apparatus (10) for coating a foodstuff product with flowable material, the apparatus comprising:
a conveying system (1, 2) for feeding in a direction of advance (K) a succession of rows of products (Q) oriented in a direction transverse to the direction of advance (K), wherein the products of said succession of rows are arranged along a plurality of reference axes (Yi) parallel to the direction of advance (K),
wherein said conveying system includes a first conveyor (1) defining a first conveying surface (I) and a second conveyor (2) defining a second conveying surface (II) set downstream of said first conveying surface (I) with reference to said direction of advance (K) and underneath said first conveying surface (I), and
wherein each row of products (Q) is transferred from said first conveying surface (I) to said second conveying surface (II) and is received on said second conveying surface (II) in a first position (P1) in said direction of advance (K); and
a system for supply (100) of flowable material configured to:
supply a group of flows of material (F1) that follow paths of supply in a direction of supply (K′) opposite to the direction of advance (K) of said succession of rows of products, said paths of supply being parallel to one another and being in positions staggered, in a direction transverse to the direction of advance, with respect to the plurality of reference axes (Yi);
gather the material of said group of flows of material in said first position (P1) on said second conveying surface (II), forming thereon substrates of said material in positions aligned with said plurality of reference axes (Yi) in order to coat undersides of the products of the rows of products that deposit on said substrates (M) when they are received in said first position (P1) on said second conveying surface (II); and
supply a further flow of material or a further group of flows of material (F2) to a second position (P2) on said second conveying surface (II) that is located downstream of said first position (P1) in said direction of advance (K) in order to coat upper sides of the products (Q) of the rows of products that reach said second position (P2) as they advance in said direction of advance (K).

8. The apparatus according to claim 7, wherein said supply system (100) comprises a chute (20) positioned above said second conveying surface (II) of said second conveyor (2) and configured to supply by gravity said material in said direction of supply (K′), wherein said chute (20) comprises a distribution sector (24), which includes:
a series of outlets (26) arranged in said second position (P2) on said second conveying surface (II) and aligned with said plurality of reference axes (Yi), and
a series of passages (28) arranged, two by two, on either side of each outlet (26) of said series of outlets and configured to supply said material to said first position (P1) on said second conveying surface (II) of said second conveyor (2).

9. The apparatus according to claim 7,
wherein said supply system (100) comprises a barrier member (32) provided on said second conveying surface (II) for blocking said group of flows of material (F1) in said first position (P1) so as to gather the corresponding material in said first position (P1).

10. The apparatus according to claim 9, wherein said barrier member (32) is configured to define on said second conveying surface (II), in said first position (P1), a series of housings (34) aligned with said plurality of reference axes (Yi), within which said material is gathered in the form of substrates (M).

11. The apparatus according to claim 10, wherein said barrier member (32) includes a series of deviator elements (36) configured to delimit inlets (38) to said housings (34) and to direct the material of said group of flows of material (F1) towards the inside of said housings (34).

12. The apparatus according to claim 11, wherein said series of deviator elements (36) comprises:
two outer deviator elements (36A), which have respective inclined surfaces (37) configured to intercept two outer flows of material of said group of flows of material (F1) and direct them, respectively, into two outer housings (34) of said series of housings;
intermediate deviator elements (36B), each having a wedge-shaped profile in plan view for dividing a respective flow of material (F1) of said group of flows of material into two partial flows (F1^{I}, F1^{II}) that are directed by the deviator element into two consecutive housings (34) of said series of housings (34).

13. The apparatus according to claim 7, configured to implement a method.
